(19) United States
(12) Patent Application Publication
(10) Pub. No.: US 2012/0162574 A1
(43) Pub. Date: Jun. 28, 2012

(54) METHOD FOR MANUFACTURING COLOR FILTER FILM, DISPLAY DEVICE AND LIQUID CRYSTAL DISPLAY DEVICE USING THE COLOR FILTER SUBSTRATE

(75) Inventors: SHENG-CHANG CHEN, Miao-Li County (TW); WEI-LUN LIAO, Miao-Li County (TW)

(73) Assignee: CHIMEI INNOLUX CORPORATION, Miao-Li County (TW)

(21) Appl. No.: 13/205,645

(22) Filed: Aug. 9, 2011

(30) Foreign Application Priority Data
Dec. 24, 2010 (CN) 201010604382.0

(51) Int. Cl. G02F 1/1335; B05D 5/06; B05D 3/00; G02F 1/167

(52) U.S. Cl. 349/62; 359/296; 427/162

(57) ABSTRACT

A method for manufacturing a color filter substrate, a display device, and liquid crystal display device using the color filter substrate are provided. The method for manufacturing the color filter substrate includes following steps. A cave is formed in a flexible base by a laser. A color filter element is formed in the cave by an inkjet printing method, so that the color filter substrate is formed by the base and the color filter element. The color filter substrate including the cave and the color filter element is formed by a roll to roll process.

This application claims the benefit of Taiwan application Serial No. 099146325, filed Dec. 28, 2010, the subject matter of which is incorporated herein by reference.

### BACKGROUND

1. Technical Field

The disclosure relates in general to a display device and a method for manufacturing the same, and more particularly to a color filter substrate and a method for manufacturing the same.

2. Description of Related Art

A color filter substrate enables a display device to display a color image. The color filter substrate includes color filter elements disposed at different positions of a base, such as a red filter element, a green filter element and a blue filter element. In general, the manufacturing process of the color filter element includes a photolithography step, and a temperature of the photolithography step is up to over 200° C.

The base of the color filter substrate of a flexible display device is usually made from a flexible material such as a polymer of polyethylene terephthalate (PET), etc. However, the glass transition temperature (Tg) of the polymer substrate is usually much lower than the temperature of the photolithography process (for example, the glass transition temperature of polyethylene terephthalate is about 80° C.). Thus, the polymer substrate is not suitable for the photolithography process.

In a typical process for forming the color filter substrate, a color filter element is formed by performing a photolithography step, etc., to a glass substrate capable of enduring a high temperature. Then, the color filter element on the glass substrate is pasted on the polymer substrate. However, such manufacturing process is complicated, the probability of the defect of the product is increased and the yield rate is thus decreased. In addition, the selection of the material of the substrate is limited, thus the cost is high. Furthermore, the color filter substrate formed by the pasting may have other thin film such as glass besides the polymer substrate, thus the light transmittance of the display device using the multi-layered color filter substrate is decreased and cannot be a flexible one.

### SUMMARY OF THE DISCLOSURE

According to an aspect of the present disclosure, a method for manufacturing a color filter substrate is provided. The manufacturing method includes following steps. A cave is formed in a base by a laser. A color filter element is formed in the cave. The color filter substrate is formed by the base and the color filter element.

According to another aspect of the present disclosure, a display device is provided. The display device includes a display and a color filter substrate. The display includes a first electrode layer, a second electrode layer and a photoelectronic element having an electrophoretic fluid. The photoelectronic element is disposed between the first electrode layer and the second electrode layer. The color filter substrate is disposed on the display. The color filter substrate includes a flexible base, a cave and a color filter element. The cave is located in the base and is formed by a laser. The color filter element is located in the cave.

According to yet an aspect of the present disclosure, a liquid crystal display device is provided. The liquid crystal display device includes a backlight module and a liquid crystal display panel. The liquid crystal display panel is disposed on the backlight module. The liquid crystal display panel includes a color filter assembly, a thin-film transistor substrate and a liquid crystal layer. The liquid crystal layer is disposed between the color filter assembly and the thin-film transistor substrate. The color filter assembly includes an electrode layer and a color filter substrate on the electrode layer, and the color filter substrate includes a flexible base, a cave and a color filter element. The cave is located in base and formed by a laser. The color filter element is located in the cave.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIGS. 1-2 show a manufacturing process for a color filter substrate according to an embodiment of the disclosure.

FIG. 3 shows a manufacturing process for a color filter substrate according to an embodiment of the disclosure.

FIG. 4 shows a color filter substrate according to an embodiment of the disclosure.

FIG. 5 shows a display device of the first embodiment of the disclosure.

FIG. 6 shows a display device of the second embodiment the disclosure.

FIG. 7 shows a display device of the third embodiment of the disclosure.

### DETAILED DESCRIPTION OF THE DISCLOSURE

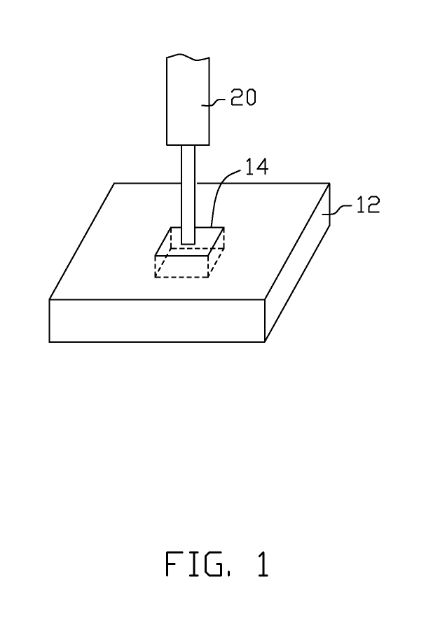

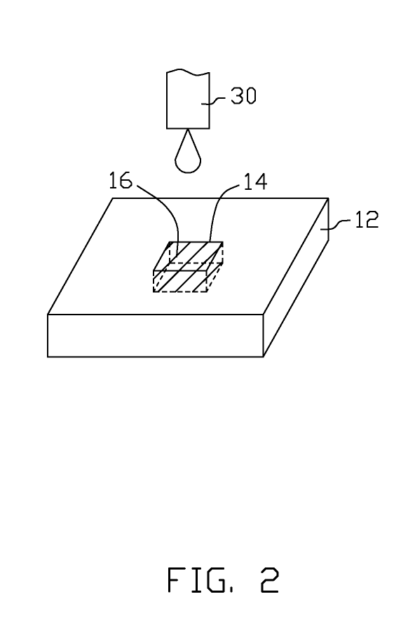

FIGS. 1-2 show a manufacturing process for a color filter substrate according to an embodiment of the disclosure. As indicated in FIG. 1, a cave 14 is formed in a base 12. In an embodiment, the cave 14 is formed by melting the base 12 by a laser 20. Since the formation of the cave 14 does not relate to a high temperature environment, the method of the present embodiment is applicable to the base 12 made from various materials, such as a flexible polyethylene terephthalate (PET). In addition, the position, the area and the depth of the cave 14 can be accurately controlled by adjusting the size and the energy of the light spot of the laser 20, so the yield rate can be largely increased.

As indicated in FIG. 2, next, a color filter element 16 is formed in the cave 14. For example, the method for forming the color filter element 16 may include an inkjet printing method. For example, in the inkjet printing method, an ink drop such as a red, green or blue ink drop is infused into the cave 14 by a spray nozzle 30 to form the color filter element 16, such as a red, blue or green color filter element.

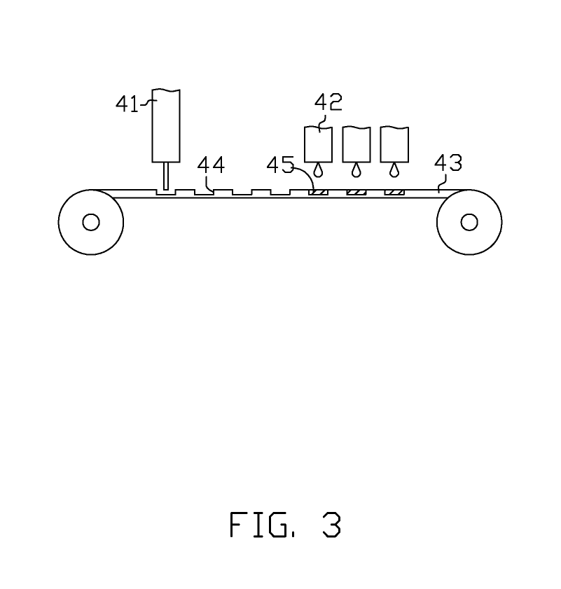

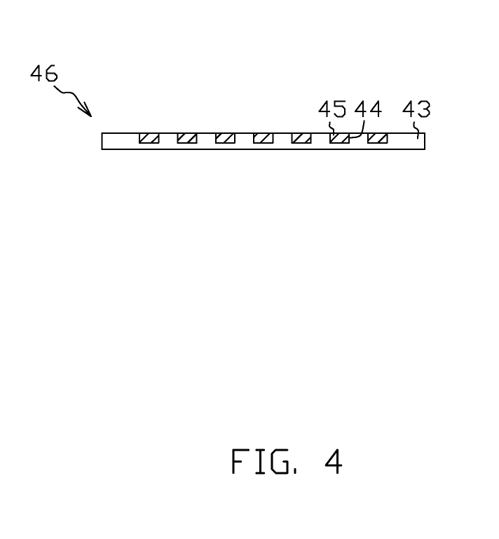

FIG. 3 shows a manufacturing process for a color filter substrate according to an embodiment of the disclosure. FIG. 4 shows a color filter substrate according to an embodiment of the disclosure. As indicated in FIG. 3, the cave 44 and the color filter element 45 are respectively formed in the base 43 continuously by the laser 41 and the spray nozzle 42 by a roll to roll process so as to form the color filter substrate 46 as shown in FIG. 4. Therefore, the manufacturing process is fast and simple. In other embodiments, after the color filter element 45 is formed, a covering layer (not illustrated) can be coated on the side of the color filter substrate 46 adjacent to the color filter element 45 for flattening the color filter substrate 46. The color filter substrate 46 can also be cut to suitable size to fit the user's needs.

The color filter substrate manufactured by the method of the embodiment of the present disclosure has a simple structure. That is, the color filter element is directly formed in the cave of the base. Thus, the display device using the color filter substrate of the embodiment of the present disclosure has fewer layers, and light transmittance is thus increased. Furthermore, the manufacturing cost of the display device is low. Several embodiments are exemplified below.

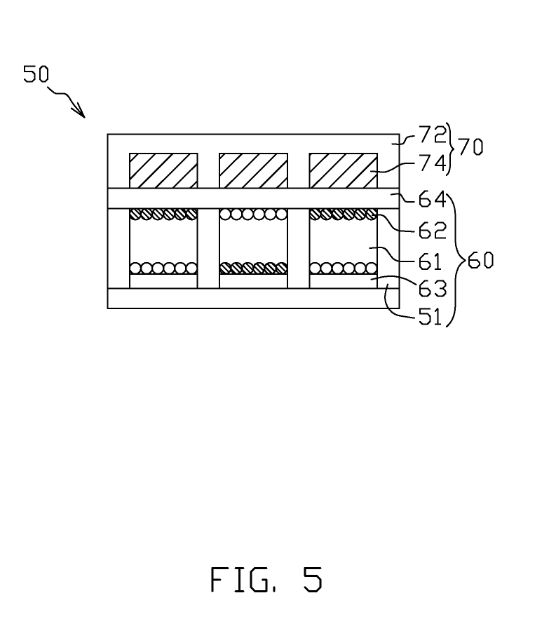

FIG. 5 shows a display device of the first embodiment of the disclosure. As indicated in FIG. 5, the display device 50 includes a display 60 and a color filter substrate 70. The display 60 can be realized by a flexible display. For example, the display 60 includes a photoelectronic element 61, an electrode layer 63, and an electrode layer 64. The photoelectronic element 61 is disposed between the electrode layer 63 and the electrode layer 64. The photoelectronic element 61 includes an electrophoretic fluid 611 and an electrophoretic particle 612. The color filter substrate 70 includes a flexible base 72 and a color filter element 74 formed in the flexible base 72. For example, the color filter element 74 can be realized by a red, green or blue color filter element. For example, the display device 50 is an electronic paper display device. In the present embodiment, the display device 50 can be realized by a microcup electrophoretic display structure. The electrophoretic fluid 611 of the microcup electrophoretic display structure is an electrophoretic solution. The electrophoretic fluid 611, the electrophoretic particle 612 and the electrode layer 63 can be disposed in a spacer 51 having a microcup structure. In addition, in other embodiments, the display device 50 can be realized by a quick response liquid powder display structure which is similar to the microcup electrophoretic display structure except that the electrophoretic fluid 611 is replaced by an electrophoretic gas using a gas as a dielectric material.

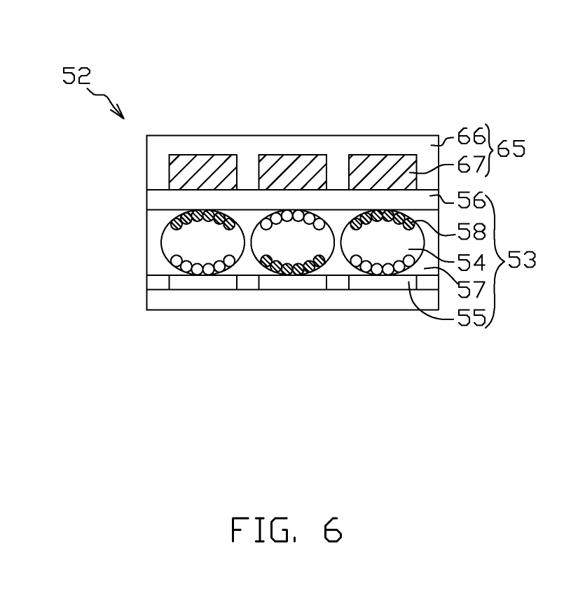

FIG. 6 shows a display device of the second embodiment of the disclosure. As indicated in FIG. 6, the display device 52 includes a display 53 and a color filter substrate 65. The display 53 can be realized by a flexible display. The display 53 of the present embodiment of the disclosure is different from the display device 50 of FIG. 5 in that the display 53 of the present embodiment of the disclosure can be realized by a microcapsulation electrophoretic display structure whose electrophoretic fluid 54 is also an electrophoretic solution, and that the electrophoretic particle 58 and the electrophoretic fluid 54 are disposed in the photoelectronic element 57 of microcapsulation structure.

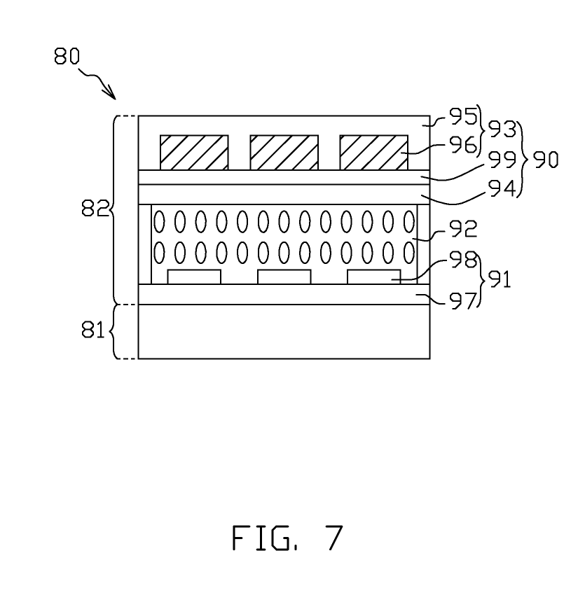

FIG. 7 shows a display device of the third embodiment of the disclosure. As indicated in FIG. 7, the display device 80 can be realized by a liquid crystal display device, and includes a backlight module 81 and a liquid crystal display panel 82. The liquid crystal display panel 82 is disposed on the backlight module 81. The liquid crystal display panel 82 may include a color filter assembly 90, a thin-film transistor substrate 91 and a liquid crystal layer 92. The liquid crystal layer 92 is disposed between the color filter assembly 90 and the thin-film transistor substrate 91. The color filter assembly 90 includes a color filter substrate 93, an electrode layer 94 and a base 99. The base 99 may include glass. In the present embodiment, the color filter substrate 93 is disposed on the base 99 after the color filter substrate 93 is formed, so that the base 99 is less likely to be damaged resulted from a fault of a process for the color filter substrate 93. In addition, in other embodiments, the color filter assembly 90 may only include the color filter substrate 93 and the electrode layer 94 but not the base 99. The color filter substrate 93 includes a base 95 and a color filter element 96 formed in the base 95. For example, the color filter element 96 is a red color filter element, a green color filter element and blue color filter element. The thin-film transistor substrate 91 includes a base 97 and an electrode layer 98.

In the embodiments of the present disclosure, in the method for manufacturing the color filter substrate, the cave is formed by melting the base by a laser. Since the formation of the cave does not relate to high temperature environment, the method of the present embodiment is applicable to various flexible polymer materials. In addition, the cave can be accurately controlled by adjusting the parameter of the laser, thus the product yield rate can be largely increased. The cave and the color filter element are formed by a roll to roll process continuously, so the manufacturing process is fast and simple. Since the color filter substrate has a simple structure, the display device using the color filter substrate can have fewer layers, so that the light transmittance is increased. Furthermore, the manufacturing cost of the display device is reduced.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for manufacturing a color filter substrate, comprising:
forming a cave in a base by a laser; and
forming a color filter element in the cave, so that the color filter substrate is formed by the base and the color filter element.

2. The method for manufacturing the color filter substrate according to claim 1, wherein the method of forming the color filter element comprises an inkjet printing method.

3. The method for manufacturing the color filter substrate according to claim 2, wherein the base is flexible and the color filter substrate comprising the cave and the color filter element is formed by a roll to roll process.

4. The method for manufacturing the color filter substrate according to claim 1, wherein the base is flexible, and the color filter substrate comprising the cave and the color filter element is formed by a roll to roll process.

5. The method for manufacturing the color filter substrate according to claim 1, wherein the color filter substrate is used in a display device.

6. The method for manufacturing the color filter substrate according to claim 5, wherein the display device comprises a liquid crystal display device or an electronic paper display device.

7. A display device, comprising:
a display, comprising:
a first electrode layer;
a second electrode layer; and
a photoelectronic element having an electrophoretic fluid, wherein the photoelectronic element is disposed between the first electrode layer and the second electrode layer; and
a color filter substrate disposed on the display, wherein the color filter substrate comprises:
a flexible base;
a cave located in the base and formed by a laser; and
a color filter element located in the cave.

8. The display device according to claim 7, wherein the display is a microcapsulation electrophoretic display structure or a microcup electrophoretic display structure, the photoelectronic element further comprises electrophoretic particles disposed in the electrophoretic fluid, and the electrophoretic fluid is an electrophoretic solution.

9. The display device according to claim 7, wherein the display is a quick response liquid powder type display structure, the photoelectronic element further comprises electrophoretic particles disposed in the electrophoretic fluid, and the electrophoretic fluid is an electrophoretic gas.

10. The display device according to claim 7, wherein the display device is an electronic paper display device.

11. A liquid crystal display device, comprising:
a backlight module; and
a liquid crystal display panel disposed on the backlight module, wherein the liquid crystal display panel comprises a color filter assembly, a thin-film transistor substrate and a liquid crystal layer, the liquid crystal layer is disposed between the color filter assembly and the thin-film transistor substrate, and the color filter assembly comprises:
an electrode layer; and
a color filter substrate disposed on the electrode layer, wherein the color filter substrate comprises:
a flexible base;
a cave located in the base and formed by a laser; and
a color filter element located in the cave.
